(19) United States
(12) Patent Application Publication
(10) Pub. No.: US 2002/0181822 A1
(43) Pub. Date: Dec. 5, 2002

(54) Reduced power consumption thermo-optic devices

(75) Inventors: Christopher R. Doerr, Middletown, NJ (US); John Gates, New Providence, NJ (US); Dirk Muehlner, Muray Hill, NJ (US); Robert M. Pafchek, Blandon, PA (US)

Correspondence Address: IP Department, Schnader Harrison Segal & Lewis LLP, 1600 Market Street, Suite 3600, Philadelphia, PA, 19103, US

(73) Assignee: Agere Systems Inc.

(21) Appl. No.: 09/852,419

(22) Filed: May 10, 2001

(51) Int. Cl. G02F 1/035

(52) U.S. Cl. 385/3

(57) ABSTRACT

An apparatus and method for reducing the power needed to operate a thermo-optic switch using a heat sensitive optical phase shifter which is controlled by an electrically powered metal heater strip attached to the optical waveguide of the phase shifter. The power can be reduced by reducing the thickness of the upper cladding to 15 microns or less, increasing the thickness of the lower cladding to more than 15 microns, and adjusting the index contrast (Δ) of the materials comprising the upper cladding, the lower cladding, and the core of the waveguide so that it is greater than 0.4%.

### BACKGROUND OF THE INVENTION

1. Field of the Invention

The present invention relates to phase shifer thermo-optic devices which use a change in temperature on the waveguide core to effect the change in phase, and more particularly to thermo-optic switches which are controlled by a voltage applied across a section of the waveguide to cause the swift in phase.

2. Description of the Prior Art

Optical waveguides often consist of a phosphorous doped silicon dioxide waveguide core sandwiched between depositions of upper and lower cladding material all on a silicon wafer. The upper cladding material is often silica glass made from phosphorous and boron doped silicon dioxide. The lower cladding material is often made of silicon dioxide. Other well known materials can be used for the upper and lower cladding. Most light power propagates in the core of the waveguide. Some light power propagates in the cladding. If the claddings are thick enough, light power will not be lost. But if the claddings are too thin, light power will be lost. Therefore, the claddings for use in optical waveguides have been made thick enough to prevent loss of light power.

It is also known that the index of refraction of optical waveguides made from phosphorous or Germanium doped silicon dioxide is slightly sensitive to temperature. As a result, changes in the temperature of the waveguide core cause the phase of the light traveling through a waveguide to change. Controlled changes in temperature control the phase of the light propagating through the waveguide thereby changing the intensity of the light exiting from an interferometer containing such a phase shifter.

Using the core's temperature sensitive characteristics, a waveguide can be used as a thermo-optic phase shifter by placing a metal heater strip on a segment of the waveguide and connecting the metal heater strip to an electrical power source. Variations in the voltage change the temperature of the metal strip, thereby changing the phase of the light through the waveguide and therefore the intensity of the light exiting the core.

Thermo-optic switches consisting of electrically controlled thermo-optic phase shifters are often used as building blocks in complex integrated optical device designs. Because many voltage controlled thermo-optic switches are often used in a single device, the amount of power used has become an issue and there is a need to design thermo-optic switches which minimize the amount of needed electrical power.

It is known how to make a thermo-optic phase shifter in glass waveguides. It is also known that the electrical power consumption per achieved phase shift can be decreased by increasing the thickness of the lower cladding and/or decreasing the thickness of the upper cladding.

### SUMMARY OF THE INVENTION

An advantage of an embodiment of the invention is to minimize the electrical power applied to a waveguide in order to change the temperature of the core thereby changing the phase of the light exiting the waveguide. Since the change in temperature of the waveguide core is inversely proportional to the thickness of the upper cladding for a given voltage, thicker upper cladding causes lower core temperatures, thereby requiring the input of more electrical power in order to achieve the temperature needed to effect the needed phase change of the light.

The present invention is directed to a device for decreasing the amount of power needed to control a waveguide thermo-optic switch by changes in temperature. Since higher temperatures develop on the core for a given voltage as the upper cladding is made more thin, the present invention uses an upper cladding thickness which is equal to or less than 15 microns. In one embodiment of our invention, the thickness of the upper cladding is 15 microns and the thickness of the lower cladding is 30 microns.

Another advantage of an embodiment of the present invention is to reduce the needed electrical power input by optimizing the relationship between the thickness of the upper cladding, the thickness of the lower cladding, and the difference between the index contrast of the materials used for the core of the waveguide compared to the index contrast of the materials used for the upper cladding and the lower cladding.

### BRIEF DESCRIPTION OF THE DRAWINGS

FIG. 1 is a three dimensional drawing of a thermo-optic switch according to an embodiment of the present invention.

FIG. 2 is a vertical cross-section view taken near the front edge of the device in FIG. 1.

### DETAILED DESCRIPTION OF THE INVENTION

The invention will be understood more fully from the detailed description given below and from the accompanying drawings of one embodiment of the invention which, however, should not be taken to limit the invention to a specific embodiment, but is for explanation and understanding only.

The embodiment described here relates to quantitative design parameters that minimize the electrical power consumption without significantly affecting optical waveguide performance and mechanical integrity due to thermal expansion coefficient mismatch concerns.

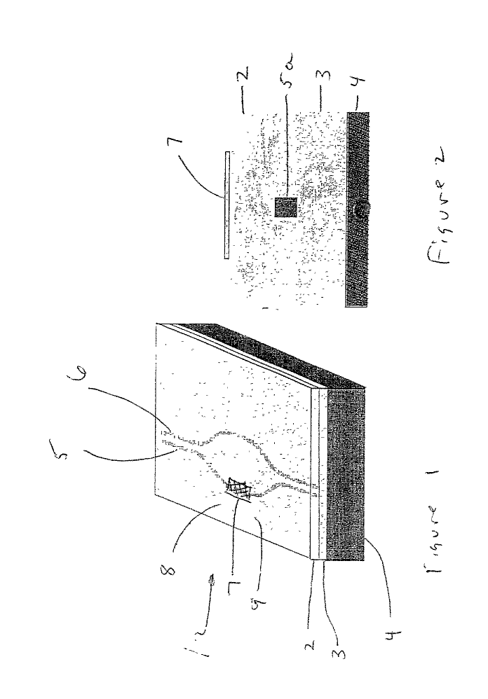

Referring to FIG. 1, there is shown a three-dimensional drawing of the thermo-optic switch 1 of this invention. The switch includes upper cladding 2, lower cladding 3, and a substrate 4. The upper cladding 2 is silica glass made of phosphorous and boron doped silicon dioxide. The lower cladding 3 is made of silicon dioxide. The substrate 4 is made of silicon.

Sandwiched between the upper cladding 2 and the lower cladding 3 are two optical waveguides 5 and 6 made from phosphorous doped silicon dioxide. Other dopants such as Germanium can be substituted for phosphorous. Optical waveguides 5 and 6 traverse the entire length of the switch 1. A metal heater strip 7 is patterned and deposited onto upper cladding 2 above waveguide 5. Metal heater strip 7 is made of chromium, but may be made of other materials known to those skilled in the art. Two electrodes 8 and 9 are attached to metal heater strip 7. Electrodes 8 and 9 are made of gold, but may be made of other materials known to those skilled in the art. When a voltage is applied to metal heater strip 7 through electrodes 8 and 9, the temperature of waveguide 5 is increased thereby causing a shift in the phase of the light traversing waveguide 5 relative to the light traversing waveguide 6 and changing the intensity of the light exiting from thermo-optic switch 1.

FIG. 2 is a partial vertical cross section view taken near the front edge of the device shown in FIG. 1. The left side of FIG. 2 coincides with the left side of FIG. 1 and the right side of FIG. 2 is located betweem waveguides 5 and 6 shown in FIG. 1. FIG. 2 does not show waveguide 6. The core 5a is the high index region of waveguide 5 as seen in a cross-section view. In the present embodiment, the thickness of the upper cladding 2 is preferably equal to or less than approximately 15 microns and the thickness of the lower cladding 3 is more than approximately 15 microns. For example, in one exemplary embodiment of our invention, the thickness of the upper cladding 2 is 15 microns and the thickness of the lower cladding 3 is 30 microns.

The thickness of the upper cladding 2 is also a function of relationship between the refractive indexes of the materials used for the core 5a of waveguide 5, the upper cladding 2, and the lower cladding 3. The use of higher index materials for the core results in confining the optical power more tightly to the core. Therefore, the use of higher index materials for the core 5a allows the use of a thinner upper cladding 2. In turn, the use of thinner upper cladding 2 will allow lower electrical power input for the same phase shift in light exiting from waveguide 5. The relationship of the index contrasts among the upper cladding 2, the lower cladding 3, and the core 5a is defined by the fraction

$$\frac{( index of core ) - ( index of cladding )}{index of core} = Δ$$

This fraction is referred to as the index contrast or Δ. Our invention uses a Δ greater than 0.4%. In one embodiment of our invention, the Δ is approximately 0.65% and materials providing a 0.65%Δ are used in combination with an upper cladding thickness 2 of 15 microns and a lower cladding thickness 3 of 30 microns. Using this combination of elements, power consumption is reduced by 13% over the case where the upper cladding thickness 2 is 18 microns.

When materials providing an index contrast Δ of 0.8% are used, the height of the core is 6 microns and thickness of the upper cladding 3 is reduced to 11 microns. As higher index contrasts are achieved, the upper cladding 3 can be reduced further and will result in the use of lower power.

While the invention has been described with specificity, additional advantages and modifications will readily occur to those skilled in the art. Therefore, the invention in its broader aspects is not limited to the specific details shown and described herein. Accordingly, various modifications may be made without departing from the spirit or scope of the general inventive concepts as defined by the appended claims and their equivalents.

We claim:

1. A thermo-optic phase shifter in silica waveguides tailored for low electrical power consumption and low optical loss comprising a core sandwiched between upper cladding and lower cladding, where a thickness of the upper cladding is substantially the same or less than a thickness of the lower cladding.

2. The thermo-optic phase shifter of claim 1, wherein the thickness of the upper cladding is approximately 15 microns.

3. The thermo-optic phase shifter of claim 1, wherein the thickness of the upper cladding is less than approximately 15 microns.

4. The thermo-optic phase shifter of claim 1 wherein the thickness of the lower cladding is greater than approximately 15 microns.

5. The thermo-optic phase shifter of claim 1, wherein the thickness of the lower cladding is approximately 30 microns.

6. The thermo-optic phase shifter of claim 1, wherein
(a) said core has a first index of refraction;
(b) said cladding has a second index of refraction; and
(c) the relationship between said first and second indexes of refraction is defined by the fraction
$$\frac{( index of core ) - ( index of cladding )}{index of the core} = Δ ; and$$
(d) Δ is greater than 0.4%.

7. The thermo-optic phase shifter of claim 1, wherein
(a) said core has a first index of refraction;
(b) said cladding has a second index of refraction; and
(c) the relationship between said first and second indexes of refraction is defined by the fraction
$$\frac{( index of core ) - ( index of cladding )}{index of the core} = Δ ; and$$
(d) Δ is approximately 0.65%.

8. The thermo-optic phase shifter of claim 6, wherein the thickness of the lower cladding is greater than approximately 15 microns.

9. The thermo-optic phase shifter of claim 7, wherein the thickness of the lower cladding is 30 microns.

10. The thermo-optic phase shifter of claim 1, wherein the thermo-optic phase shifter comprises an optical waveguide, a metal heater strip placed on said optical waveguide, and first and second electrodes attached to said metal heater strip for causing a heat generating current to pass through said metal heater strip.

11. The thermo-optic phase shifter of claim 10 wherein the thickness of the lower cladding is greater than approximately 15 microns.

12. The thermo-optic phase shifter of claim 11, wherein the thickness of the lower cladding is 30 microns.

13. The thermo-optic phase shifter of claim 10, wherein
(a) said core has a first index of refraction;
(b) said cladding has a second index of refraction;
(c) the relationship between said first and second indexes of refraction is defined by the fraction
$$\frac{( index of core ) - ( index of cladding )}{index of the core} = Δ ; and$$
(d) wherein Δ is greater than 0.4%.

14. The thermo-optic phase shifter of claim 10, wherein
(a) said core has a first index of refraction;
(b) said cladding has a second index of refraction;
(c) the relationship between said first and second indexes of refraction is defined by the fraction
$$\frac{( index of core ) - ( index of cladding )}{index of the core} = Δ ; and$$
(d) wherein Δ is approximately 0.65%.

15. The thermo-optic phase shifter of claim 13, wherein the thickness of the lower cladding is greater than approximately 15 microns.

16. The thermo-optic switch of claim 14, wherein the thickness of the lower cladding is 30 microns.

17. A thermo-optic phase shifter in silica waveguides tailored for low electrical power consumption and low optical loss comprising a core sandwiched between upper cladding which has a thickness of less than approximately 15 microns and lower cladding.

18. The thermo-optic phase shifter of claim 17 wherein the thickness of the lower cladding is greater than approximately 15 microns.

19. The thermo-optic phase shifter of claim 17, wherein the thickness of the lower cladding is 30 microns.

20. The thermo-optic phase shifter of claim 17, wherein
(a) said core has a first index of refraction;
(b) said cladding has a second index of refraction; and
(c) the relationship between said first and second indexes of refraction is defined by the fraction
$$\frac{( index of core ) - ( index of cladding )}{index of the core} = Δ ; and$$
(d) Δ is greater than 0.4%.

21. The thermo-optic phase shifter of claim 20, wherein the thickness of the lower cladding is greater than approximately 15 microns.

22. The thermo-optic phase shifter of claim 17, wherein the thermo-optic phase shifter comprises an optical waveguide, a metal heater strip placed on said optical waveguide, and first and second electrodes attached to said metal heater strip for causing a heat generating current to pass through said metal heater strip.

23. The thermo-optic phase shifter of claim 22 wherein the thickness of the lower cladding is greater than 15 microns.

24. The thermo-optic phase shifter of claim 17, wherein
(a) said core has a first index of refraction;
(b) said cladding has a second index of refraction;
(c) the relationship between said first and second indexes of refraction is defined by the fraction
$$\frac{( index of core ) - ( index of cladding )}{index of the core} = Δ ; and$$
(d) wherein Δ is greater than 0.4%.

25. A method for reducing the power needed to operate a thermo-optic phase shifter comprising:
(a) reducing the thickness of the upper cladding to approximately 15 microns or less;
(b) increasing the thickness of the lower cladding to greater than approximately 15 microns.
(c) determining the relationship between the index of refraction of the core and the index of refraction of the cladding according to the fraction
$$\frac{( index of core ) - ( index of cladding )}{index of the core} = Δ .$$

26. The method of claim 25 including the step of choosing materials for said core and said cladding such that Δ is greater than 0.4%.

27. The method of claim 25 including the step of choosing materials for said core and said cladding such that Δ is approximately 0.65%.
